(19) United States
(12) Patent Application Publication
(10) Pub. No.: US 2026/0138511 A1
(43) Pub. Date: May 21, 2026

(54) LOCKING DEVICE FOR SEATBACK

(71) Applicant: DAS CO., LTD, Gyeongju-si (KR)

(72) Inventors: Jun Hak LEE, Osan-si (KR); Yong Chang JUNG, Hwaseong-si (KR)

(21) Appl. No.: 18/991,937

(22) Filed: Dec. 23, 2024

(30) Foreign Application Priority Data
Nov. 21, 2024 (KR) 10-2024-0167452

(51) Int. Cl. B60N 2/36

(52) U.S. Cl. CPC B60N 2/366

(57) ABSTRACT

A locking device is disclosed of a seat back capable of preventing generation of a clearance between a striker and a latch. The locking device of a seat back includes: a hinge pin installed in a case; a first latch part rotatably installed through the hinge pin with respect to the case and having a fork for coupling to a striker; a second latch part rotatably installed through the hinge pin with respect to the case and having a restraint for preventing a flow of the striker; an interlocking structure for an interlock behavior between the first latch part and the second latch part; a first return spring configured to provide a restorative force in a locking direction with respect to the first latch part; and a second return spring configured to provide a restorative force in a locking direction with respect to the second latch part.

### CROSS REFERENCE TO RELATED APPLICATION

The present application claims priority to Korea Patent Application No. 10-2024-0167452, filed Nov. 21, 2024, the entire contents of which is incorporated herein for all purposes by this reference.

### FIELD

The present disclosure relates to a locking device of a seat back, more particularly, to a locking device of a seat back capable of preventing generation of a clearance between a striker and a latch, and reducing a quantity of components.

### BACKGROUND

In general, second-row or third-row seats of a vehicle are manufactured such that the seat back thereof is foldable forward so as to enhance utilization of the indoor space.

To this end, the conventional second-row or third row seats have a locking device capable of fixing the seat back in a standing state. In such a case, the locking device of the seat back is configured to be fastenable to the striker fixed in the vehicle body.

However, the conventional locking device of the seat back has a problem of flow noise when it is fastened to the striker, and this flow noise is attributable to a clearance generated between the locking device and the striker.

Therefore, in order to absorb the clearance between the locking device and the striker according to the prior art, methods such as superimposing a rubber damper at a fastening portion, or changing a structure of fastening between the locking device and the striker into a two-stage latch are used.

As a result, in the conventional locking device of the seat back, a structural problem of having the flow noise occurs as the damper deteriorates, and when applying the two-stage latch, components become complex, and the manufacturing cost increases.

### PRIOR ART LITERATURE

### Patent Literature

Korea Patent No. 10-2021-0058476

### SUMMARY

A technical problem to be solved by the present disclosure is to provide a locking device of a seat back capable of preventing flow of a striker by absorbing a clearance generated at a fastening portion between the striker and the latch.

One embodiment is a locking device of a seat back, including: a hinge pin installed in a case; a first latch part rotatably installed through the hinge pin with respect to the case and having a fork for coupling to a striker; a second latch part rotatably installed through the hinge pin with respect to the case and having a restraint for preventing a flow of the striker; an interlocking structure for an interlock behavior between the first latch part and the second latch part; a first return spring configured to provide a restorative force in a locking direction with respect to the first latch part; and a second return spring configured to provide a restorative force in a locking direction with respect to the second latch part, and the restraint may be formed to have an inclined structure toward an opening of the fork.

As a preferable embodiment of the present disclosure, it is preferable that the interlocking structure may include: an interlocking pin installed in the first latch part; and a pin slot provided in the second latch part and configured to movably accommodate the interlocking pin therein.

As a preferable embodiment of the present disclosure, it is preferable that the pin slot may be disposed along a trajectory having a circular arc shape set about the hinge pin.

As a preferable embodiment of the present disclosure, it is preferable that the case may include: a hinge hole hingedly coupled to the hinge pin; and a release slot movably accommodating the interlocking pin therein, and the interlocking pin may be installed to pass through the pin slot and the release slot and to be exposed outside the case.

As a preferable embodiment of the present disclosure, it is preferable that the release slot may be disposed along a trajectory having a circular arc shape set about the hinge pin, and a length of the release slot may be set to be longer than a length of the pin slot.

As a preferable embodiment of the present disclosure, it is preferable that the case may further include: a first spring support for installing the first return spring; and a guide configured to guide a strap fixed to the interlocking pin.

As a preferable embodiment of the present disclosure, it is preferable that the first latch part may include: a first hinge hole hingedly coupled to the hinge pin; and a pin hole for installing the interlocking pin.

As a preferable embodiment of the present disclosure, it is preferable that the first latch part may further include: a spring inserting portion for coupling to the first return spring; and a second spring support for installing the second return spring.

As a preferable embodiment of the present disclosure, it is preferable that the first latch part may further include a partition wall for supporting the second return spring.

As a preferable embodiment of the present disclosure, it is preferable that the first return spring may be configured as a torsion spring of which a body thereof is fixed to the first spring support, and may have one end coupled to the spring inserting portion and another end supported on a reinforcement of the case.

As a preferable embodiment of the present disclosure, it is preferable that the second latch part may include: a second hinge hole hingedly coupled to the hinge pin; and a protrusion for contacting the second return spring.

As a preferable embodiment of the present disclosure, it is preferable that the second return spring may be configured as a torsion spring of which a body thereof is fixed to the second spring support, and may have one end coupled to the partition wall of the first latch part and another end supported on the protrusion of the second latch part.

As a preferable embodiment of the present disclosure, it is preferable that the first latch part may be configured with a body made of a metal material, and a cushion made of a cushioning material, and the second spring support may be provided in the cushion.

The locking device of the seat back according to the present disclosure can absorb a clearance generated between the locking device and the first latch part in a state in which the striker is locked, therefore, there is an effect that the noise can be minimized based on stable fixing of the striker to the latch without any clearance and the manufacturing cost can be saved through simplification of components.

### BRIEF DESCRIPTION OF THE DRAWINGS

FIG. 1 is a perspective view illustrating a locking device of a seat back according to an embodiment of the present disclosure.

FIG. 2 is an exploded perspective view illustrating a cover plate, where a cover plate is broken down from a locking device of a seat back according to an embodiment of the present disclosure.

FIG. 3 is a plan view of a locking device of a seat back according to an embodiment of the present disclosure illustrated in FIG. 2.

FIG. 4 is an exploded perspective view of a locking device of a seat back according to an embodiment of the present disclosure illustrated in FIG. 2.

FIG. 5 is an exploded perspective view illustrating another embodiment of a first latch part applied in a locking device of a seat back according to an embodiment of the present disclosure.

FIG. 6 is a view illustrating an operating state of a locking device of a seat back according to an embodiment of the present disclosure.

FIG. 7 is a view for describing a manual release function implemented in a locking device of a seat back according to an embodiment of the present disclosure.

### DETAILED DESCRIPTION

Hereinafter, exemplary embodiments will be fully described with reference to the accompanying drawings.

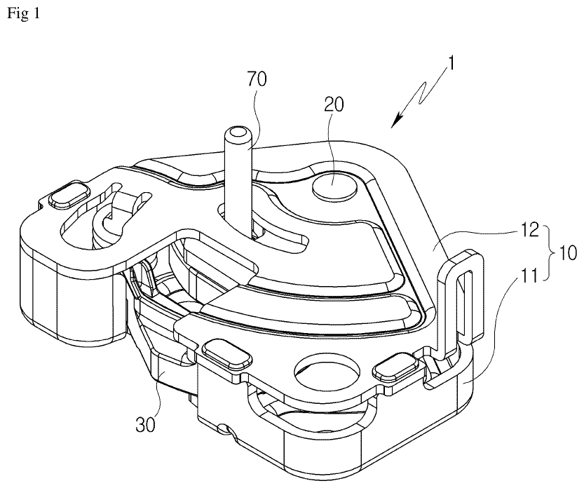

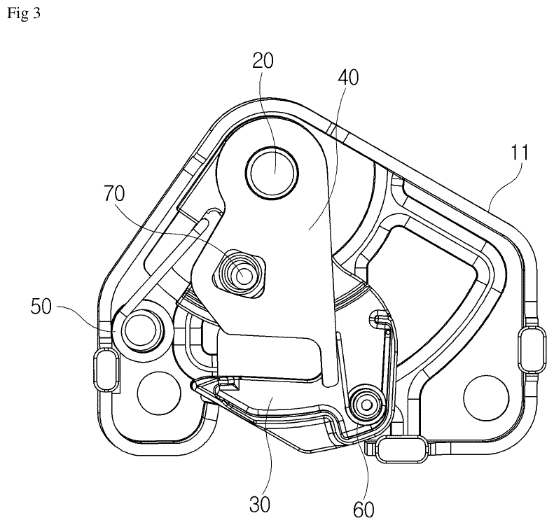

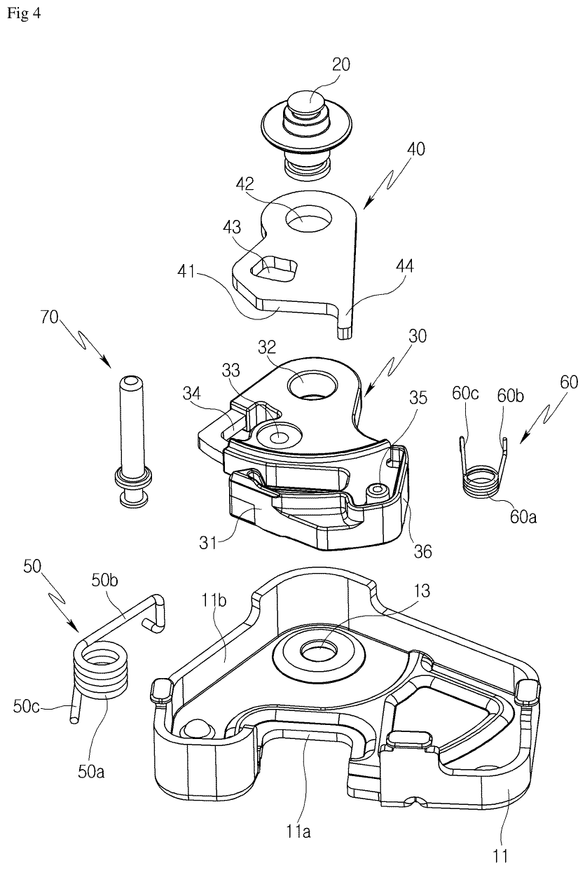

Referring to FIGS. 1 to 4, the locking device 1 according to an embodiment of the present disclosure is installed in second-row or third-row seats of a seat back and serves to stably fix the seat back in a standing state through coupling to the striker 2 having a ring shape and fixed to the vehicle body.

To this end, the locking device 1 of the seat back includes a case 10, a hinge pin 20, a first latch 30, a second latch 40, a first return spring 50, and a second return spring 60.

In particular, the locking device 1 of the seat back according to the present disclosure further includes an interlocking structure for interworking between the first latch part 30 and the second latch part 40. To this end, the locking device 1 of the seat back according to the present disclosure includes an interlocking pin 70 capable of restricting the first latch part 30 and the second latch part 40 in a manner of interlocking therebetween.

The case 10 is configured as a structure divided into shapes which are mutually assemblable into each other. For example, the case 10 may include a housing 11 and a cover plate 12. That is, the housing 11 may be manufactured in a shape of a container accommodating various components forming the locking device 1 therein. In addition, the cover plate 12 may be manufactured as a shape detachably assembled into the housing 11 and may be configured to close an accommodating space formed inside.

In addition, the case 10 has an entrance having a shape opened toward a direction in which the striker 2 enters and exits for the purpose of coupling to the striker 2, and the entrance may be configured to have a shape of an opening 11a provided on one side of the housing 11 and an opening 12a provided on one side of the cover plate 12.

In particular, the housing 11 is configured to include a reinforcement 11b extending in a vertical direction and being in contact with the first latch part 30 on both sides of the opening 11a. In this case, the reinforcement 11b is provided to surround the entire circumference of the housing 11 except the opening 11a, and the reinforcement 11b is formed to have a structure being in contact with the first latch part 30 when the first latch part 30 is in a locked state, thereby being able to respond to the external force toward a direction of detachment generated in the striker 2. That is, the reinforcement 11b provides a reaction force capable of responding to the external force through contact with the striker when the first latch part 30 is in the locked state. Accordingly, the first latch part 30 can maintain a stable fastening state with the striker 2 based on the contact with the reinforcement 11b in the locked state, and can suppress plastic deformation generated in the first latch part 30 by responding actively to the external force provided by the striker 2.

In addition, the case 10 includes a hinge hole 13, a release slot 14, and a first spring support 15.

In this case, the hinge hole 13 is provided in each of the housing 11 and the cover plate 12 for installing the hinge pin 20. Further, the release slot 14 and the first spring support 15 are provided in the cover plate 12.

In particular, the release slot 14 is provided to accommodate the interlocking pin 70 to be movable therein. At this instance, the release slot 14 is preferably configured to be disposed along a trajectory having an arc shape set about the hinge hole 13. In addition, a length of the release slot 14 is formed to be longer than a length of a pin slot 43 to be described below.

Meanwhile, the first spring support 15 is provided for installation of the first return spring 50. At this instance, the first spring support 15 may be formed in a shape of part of a member forming the cover plate 12 partially cut and bent downward.

The hinge pin 20 is configured to support the first latch part 30 and the second latch part 40 installed to be rotatable with respect to the case 10. To this end, the hinge pin 20 is inserted into the hinge hole 13 provided in each of the housing 11 and the cover plate 12 and assembled thereinto.

The first latch part 30 is hingedly coupled to the case 10 through the hinge pin 20 with respect to the case 10 and installed to be rotatable, is configured to convert the seat back into a locked state through coupling to the striker 2, and to convert the seat back into a released state from the locked state through detachment from the striker.

To this end, the first latch part 30 includes a fork 31 having an open structure opened outward for engagement with the striker 2 in a manner of rotation. In addition, the first latch part 30 includes a first hinge hole 32, a pin hole 33, and a spring inserting portion 34.

Here, the first hinge hole 32 is provided for hinged coupling with the hinge pin 20. In addition, the pin hole 33 is provided for axial coupling with the interlocking pin 70. Further, the spring inserting portion 34 is provided for coupling with an end of the first return spring 50.

Meanwhile, the first latch part 30 further includes a second spring support 35. At this instance, the second spring support 35 is provided for installation of the second return spring 60. For example, the second spring support 35 may have a shape of a protrusion protruding upward from one side of the first latch part 30.

In addition, the first latch part 30 further includes a partition wall 36. At this instance, the partition wall 36 is provided to support an end of the second return spring 60. For example, the partition wall 36 may have a shape which protrudes in a vertical direction from an edge of the first latch part 30.

The second latch part 40 is rotatably installed through the hinge pin 20 with respect to the case 10 by sharing a hinge point with the first latch part 30. In particular, when the striker 2 is converted into the locked state by the first latch part 30, the second latch part 40 serves to actively prevent a flow of the striker 2 by absorbing a clearance which may occur in a locked portion through additional contact with the striker 2.

To this end, the second latch part 40 includes a restraint 41, a second hinge hole 42, and a pin slot 43.

The restraint 41 has a structure inclined in a direction of reducing a contact angle with the striker 2 toward an opening at the entrance of the fork 31 of the first latch part 30. At this instance, a direction of an inclination had by the restraint 41 is set such that the restraint 41 restricts a flow of the striker 2 and performs a wedging action based on a close contact with the striker 2.

That is, when the striker 2 enters an inside of the fork 31, the restraint 41 is configured such that the restraint 41 can locally come into close contact with the striker 2 on an opposite side facing a contact surface between the striker 2 and the fork 31. To describe it additionally, when the striker 2 is in the locked state, one side surface of the striker 2 contacts the fork 31 of the first latch part 30, and another side surface of the striker 2 contacts the restraint 41 of the second latch part 40.

The second hinge hole 42 is provided for hinged coupling with the hinge pin 20. That is, the second hinge hole 42 is formed to share the hinge point for the hinge pin 20 with the first hinge hole 32.

The pin slot 43 is provided to accommodate the interlocking pin 70 in a movable state therein. At this instance, the pin slot 43 is preferably disposed along a trajectory in an arc shape set about the second hinge hole 42. In particular, a length of the pin slot 43 is formed shorter than a length of the release slot 14. This is to implement a manual release function to be described below.

Moreover, the second latch part 40 further includes a protrusion 44. At this instance, the protrusion 44 is provided for a contact with another end of the second return spring 60. For example, the protrusion 44 may be provided at a position adjacent to the restraint 41 on an edge of the second latch part 40.

Meanwhile, the interlocking structure is provided for an interlock behavior between the first latch part 30 and the second latch part 40, and in the embodiment of the present disclosure, the interlocking structure is implemented such that the interlocking pin 70 is inserted into the pin slot 43. In this case, the interlocking pin 70 is configured to be installed to pass through the release slot 14 in a state of being inserted into the pin slot 43 and to be exposed to the outside the case 10. Here, it is preferable that the interlocking pin 70 has a sufficient length to pass through the pin slot 43 and the release slot 14 subsequently in a state of being axially coupled to the first latch part 30 and to be exposed to the outside the case 10.

The first return spring 50 is installed so as to provide a restorative force in a locking direction with respect to the first latch part 30. For example, the first return spring 50 may be configured as a torsion spring which is installed in a state in which a body 50a at a center thereof is supported on the first spring support 15 provided in the case 10.

At this instance, one end 50b of the first return spring 50 is coupled to and supported by the spring inserting portion 34 provided in the first latch part 30. In addition, another end 50c of the first return spring 50 is in contact with and supported on the reinforcement 11b provided in the housing 11 of the case 10.

The second return spring 60 is installed to provide a restorative force in the locking direction with respect to the second latch part 40. For example, the second return spring 60 may be configured as a torsion spring which is installed in a state in which a body 60a at a center thereof is supported by the second spring support 35 provided in the first latch part 30.

At this instance, one end 60b of the second return spring 60 contacts and is supported by the partition wall 36 provided in the first latch part 30. In addition, another end 60c of the second return spring 60 is in contact with and supported on the protrusion 44 provided in the second latch part 40.

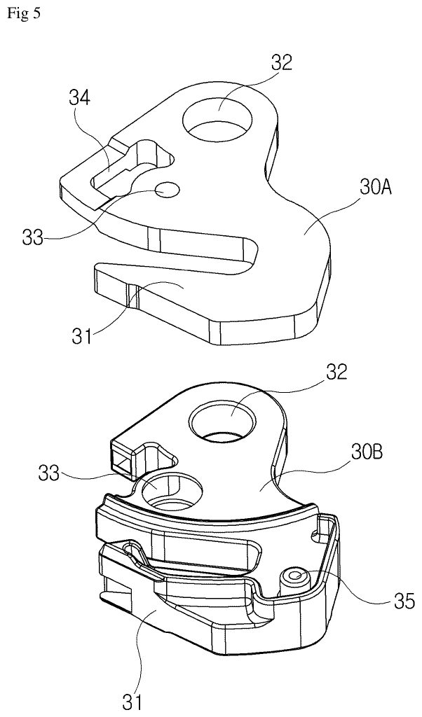

Referring to FIG. 5, as another embodiment of the present disclosure, the first latch part 30 may be configured with a body 30A made of a metal material and a cushion 30B made of a cushioning material covering an outside of the body 30A. At this instance, the cushion 30B preferably has a shape surrounding a surface of the entire components of the first latch part 30 including the fork 31. In addition, each of the body 30A and the cushion 30B preferably has the fork 31, the first hinge hole 32, and the pin hole 33. In particular, it is more preferable that the cushion 30B includes the second spring support 35 integrally formed on one side.

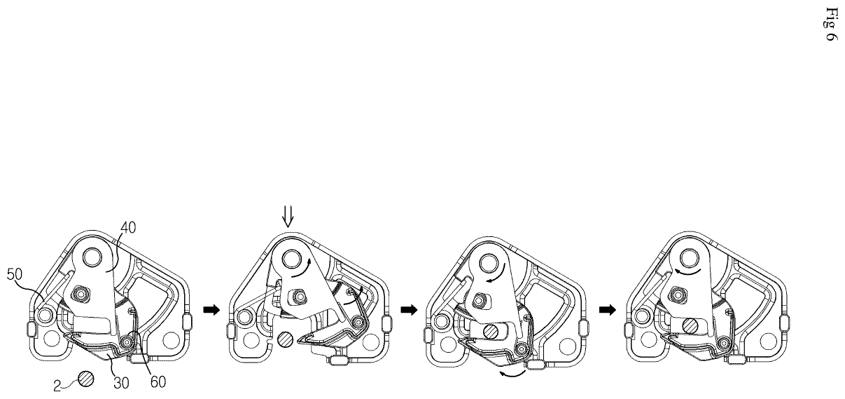

Referring to FIG. 6, when the locking device 1 contacts the striker 2 for coupling to the striker 2, the first latch part 30 rotates in the anti-clockwise direction about the hinge pin 20.

In the above course, the second latch part 40 rotates in the anti-clockwise direction about the hinge pin 20 as well through the interlocking structure according to a contact between the interlocking pin 70 and the pin slot 43, therefore, the entrance of the striker 2 is allowed.

Next, when the striker 2 enters a fastening position inside the fork 31, the first latch part 30 rotates in the clockwise direction by the restorative force of the first return spring 50, and the second latch part 40 rotates in the clockwise direction by the restorative force of the second return spring 60, thereby the striker 2 changes into the locked state from the released state.

During the above course, the restraint 41 can absorb a clearance which may occur in the striker 2 through a close contact with the fork 31.

To describe it additionally, because the fork 31 of the first latch part 30 contacts one side surface of the striker 2 when the striker 2 is in the locked state, and the restraint 41 of the second latch part 40 contacts another side surface of the striker 2, the clearance formed between the striker 2 and the first latch part 30 can be effectively suppressed through an additional contact between the restraint 41 of the second latch part 40 and the striker 2.

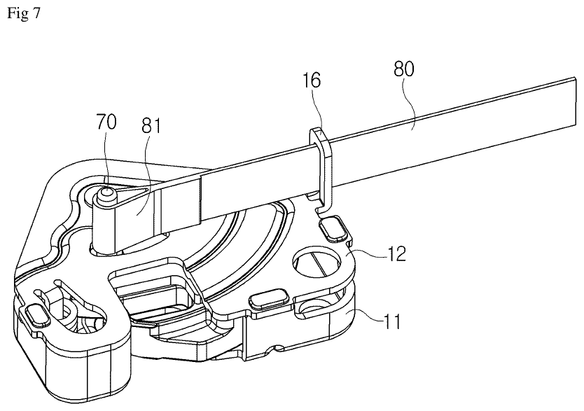

Referring to FIG. 7, the manual release function with respect to the locking device 1 may be implemented as below.

When inserting a strap 80 to the interlocking pin 70 exposed to the outside the case 10, and pulling the strap 80 in a releasing direction, the interlocking pin 70 rotates in the anti-clockwise direction about the hinge pin 20, and the first latch part 30 and the second latch part 40 interlocking with each other can rotate in the anti-clockwise direction together through the pin slot 43, thereby the locking device 1 changes into the released state from the locked state.

At this instance, the strap 80 can be replaced with various kinds of tools such as a rod which integrally includes a fixing hole 81 in a ring shape for holding the interlocking pin 70 on its free end. In addition, the strap 80 may be implemented in a structure in which the strap 80 is constantly coupled to the interlocking pin 70, rather than a structure in which the strap 80 is assembled with the interlocking pin 70.

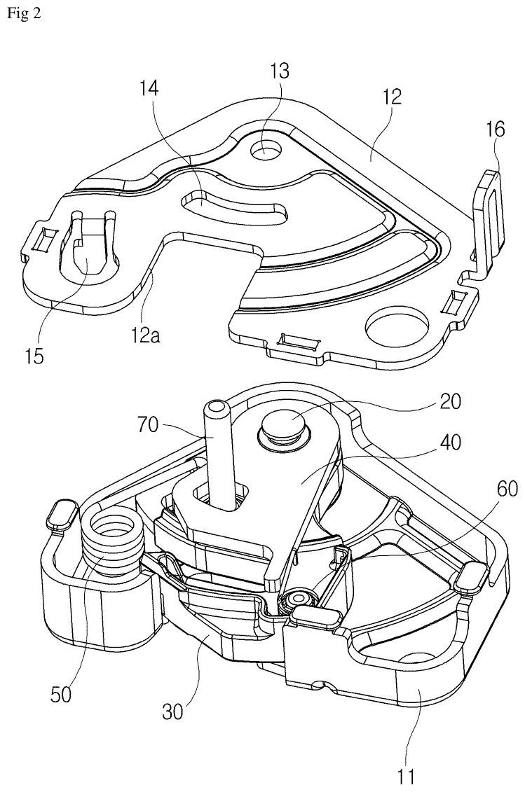

To this end, the case 10 further includes a guide 16 having a slot shape and configured to guide the strap 80 to a correct position when releasing the locking device 1 manually using the strap 80. At this instance, the guide 16 may be provided on one side of the cover plate 12, as illustrated in FIGS. 2 and 7.

REFERENCE NUMERALS

| | |
|---|---|
| 1- locking device | 2- striker |
| 10- case | 11- housing |
| 12- cover plate | 13- hinge hole |
| 14- release slot | 15- first spring support |
| 16- guide | 20- hinge pin |
| 30- first latch part | 31- fork |
| 32- first hinge hole | 33- pin hole |
| 34- spring inserting portion | 35- second spring support |
| 36- partition wall | 40- second latch part |
| 41- restraint | 42- second hinge hole |
| 43- pin slot | 44- protrusion |
| 50- first return spring | 60- second return spring |
| 70- interlocking pin | 80- strap |

What is claimed is:

1. A locking device of a seat back, comprising:
a hinge pin installed in a case;
a first latch part rotatably installed through the hinge pin with respect to the case and having a fork for coupling to a striker;
a second latch part rotatably installed through the hinge pin with respect to the case and having a restraint for preventing a flow of the striker;
an interlocking structure for an interlock behavior between the first latch part and the second latch part;
a first return spring configured to provide a restorative force in a locking direction with respect to the first latch part; and
a second return spring configured to provide a restorative force in a locking direction with respect to the second latch part,
wherein the restraint is formed to have an inclined structure toward an opening of the fork.

2. The locking device of claim 1,
wherein the interlocking structure includes:
an interlocking pin installed in the first latch part; and
a pin slot provided in the second latch part and configured to movably accommodate the interlocking pin therein.

3. The locking device of claim 2,
wherein the pin slot is disposed along a trajectory having a circular arc shape set about the hinge pin.

4. The locking device of claim 2,
wherein the case includes:
a hinge hole hingedly coupled to the hinge pin; and
a release slot movably accommodating the interlocking pin therein, and
wherein the interlocking pin is installed to pass through the pin slot and the release slot and to be exposed outside the case.

5. The locking device of claim 4,
wherein the release slot is disposed along a trajectory having a circular arc shape set about the hinge pin, and
wherein a length of the release slot is set to be longer than a length of the pin slot.

6. The locking device of claim 4,
wherein the case further includes:
a first spring support for installing the first return spring; and
a guide configured to guide a strap fixed to the interlocking pin.

7. The locking device of claim 6,
wherein the first latch part includes:
a first hinge hole hingedly coupled to the hinge pin; and
a pin hole for installing the interlocking pin.

8. The locking device of claim 7,
wherein the first latch part further includes:
a spring inserting portion for coupling to the first return spring; and
a second spring support for installing the second return spring.

9. The locking device of claim 8,
wherein the first latch part further includes a partition wall for supporting the second return spring.

10. The locking device of claim 8,
wherein the first return spring is configured as a torsion spring of which a body thereof is fixed to the first spring support, and has one end coupled to the spring inserting portion and another end supported on a reinforcement of the case.

11. The locking device of claim 9,
wherein the second latch part includes:
a second hinge hole hingedly coupled to the hinge pin; and
a protrusion for contacting the second return spring.

12. The locking device of claim 11,
wherein the second return spring is configured as a torsion spring of which a body thereof is fixed to the second spring support, and has one end coupled to the partition wall of the first latch part and another end supported on the protrusion of the second latch part.

13. The locking device of claim 8,
wherein the first latch part is configured with a body made of a metal material, and a cushion made of a cushioning material, and
wherein the second spring support is provided in the cushion.
